(19) United States
(12) Patent Application Publication
(10) Pub. No.: US 2006/0084478 A1
(43) Pub. Date: Apr. 20, 2006

(54) Most frequently used contact information display for a communication device

(75) Inventor: Shay Erlichmen, Herzelia (IL)

Correspondence Address: F. JASON FAR-HADIAN;CENTURY IP LAW GROUP, PO BOX 7333, NEWPORT BEACH, CA, 92658-7333, US

(73) Assignee: Mobile (R&D) Ltd.

(21) Appl. No.: 10/968,683

(22) Filed: Oct. 18, 2004

(51) Int. Cl. H04M 1/00

(52) U.S. Cl. 455/566; 455/418

(57) ABSTRACT

A method of displaying most frequently used information on a mobile communication device is provided. The method comprises monitoring usage of a plurality of contact information associated with a process for initiating contact with an entity, wherein said plurality of contact information is stored in a database accessible by the mobile communication device; determining N most frequently used contact information from among said plurality of contact information stored in the database; and displaying the N most frequently used contact information in a first portion of the mobile communication device's display, in response to a user request to view a list comprising the plurality of contact information stored in the database.

### BACKGROUND

1. Field of Invention

The present invention relates generally to a dialing feature in a mobile communication device and, more particularly, to a system and method for displaying most frequently used contact information by a user.

### COPYRIGHT & TRADEMARK NOTICES

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is for providing an enabling disclosure by way of example and shall not be construed to limit the scope of this invention to material associated with such marks.

2. Related Art

Mobile communication devices, particularly cellular phones are equipped with caller identification and speed dial features to assist a user with recognizing incoming calls and returning phone calls in a convenient and speedy manner. Typically, a user can store a name and a corresponding number in mobile device's memory. Later the user can retrieve and have the mobile device dial that number simply by selecting from a menu that provides a list of the stored names or numbers.

Due to the limited display capabilities of mobile devices, as the list of stored names and numbers grows longer, finding a particular number from among the many numbers stored in the list becomes more difficult. That is, the user will have to search through a longer list in order to find the particular entry associated with a target name or number, as the number of entries in the list increases.

For example, if the target entry is at the beginning of the list, the user will be able to retrieve the related information quickly. If, however, the target entry is toward the end of the list, then the user will be forced to view information stored in each preceding entry and/or continue browsing toward the end of the list, until the target entry is selected and displayed.

Some mobile devices provide sorting or searching features to expedite the process by allowing the user to perform an alphanumeric sort or search. While these features are helpful, a user must learn the requisite searching or sorting technique. These techniques can be cumbersome, particularly considering the limited keypad with which the phone is equipped. Such searches may nevertheless require the user to go through a portion of the list, if not the entire list, to find a specific entry.

In addition, some mobile phones are implemented to allow a user to program a designated key on the mobile phone's keypad for one touch dialing. This allows the user to quickly dial the programmed number by first pressing a special key and then the designated key associated with the programmed number. Unfortunately, however, this static programming approach is not a good solution to the dynamic environment in which we live. Most users don't use this feature even when it is available to them.

More dynamic and convenient systems and methods are needed that can overcome the above-noted problems.

### SUMMARY

The present disclosure is directed to a system and corresponding methods that facilitate quick display of contact information in a mobile device.

For purposes of summarizing, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

In accordance with one embodiment, a method of displaying most frequently used information on a mobile communication device is provided. The method comprises monitoring usage of a plurality of contact information associated with a process for initiating contact with an entity, wherein said plurality of contact information is stored in a database accessible by the mobile, communication device; determining N most frequently used contact information from among said plurality of contact information stored in the database; and displaying the N most frequently used contact information in a first portion of the mobile communication device's display, in response to a user request to view a list comprising the plurality of contact information stored in the database.

The contact information may comprise a telephone number, a name corresponding to a telephone number, an email address, an IP address, or other destination identifier used for communicating with a third party or entity. The database is implemented in at least one of the mobile communication device or a server system (i.e., a service provider, or 3^{rd} party portal) connected to the mobile communication device.

The first portion of mobile communication device's display comprises a prominent area of the display. The prominent area, for example, comprises a position at beginning of the list comprising the plurality of contact information stored in the database. The determining step, in an exemplary embodiment, comprises determining whether a first contact information is used more than X times. If so, then the first contact information is included in a list of N most frequently used contact information, so that it can be displayed on the mobile device.

In accordance with another aspect of the invention, a mobile communication device comprises circuitry for monitoring usage of contact information associated with a process for initiating contact with an entity, wherein said contact information is stored in a database accessible by the mobile communication device; and circuitry for determining N most frequently used contact information from among said contact information stored in the database.

Also included is the circuitry for displaying the N most frequently used contact information in a first portion of the mobile communication device's display, in response to a user request to view the contact information stored in the database. The first portion of mobile communication device's display may be located at a prominent area of the display. For example, the prominent area may comprise a position at beginning of a contact list comprising said contact information stored in the database.

Another embodiment of the invention further comprises circuitry for determining whether a first contact information is used more than X times; and circuitry for including the first contact information in a first list of N most frequently used contact information, when the first contact information is used more than X times. The first list is stored in a memory of at least one of the mobile communication device or a remote computer (i.e., service provider) connected to the mobile communication device.

These and other embodiments of the present invention will also become readily apparent to those skilled in the art from the following detailed description of the embodiments having reference to the attached figures, the invention not being limited to any particular embodiments disclosed.

### BRIEF DESCRIPTION OF THE DRAWINGS

Embodiments of the present invention are understood by referring to the figures in the attached drawings, as provided below.

FIG. 1 illustrates an exemplary communications environment, in accordance with one or more embodiments of the invention;

FIG. 2 is a flow diagram of a method of displaying one or more speed dial entries, in accordance with one or more embodiments; and

FIGS. 3A and 3B are block diagrams of hardware and software environments in which a system of the present invention may operate, in accordance with one or more embodiments.

Features, elements, and aspects of the invention that are referenced by the same numerals in different figures represent the same, equivalent, or similar features, elements, or aspects, in accordance with one or more embodiments.

### DETAILED DESCRIPTION

An electronic system and corresponding methods, according to an embodiment of the present invention, facilitate and provide a method and system for displaying contact information entries on a mobile device.

Electronic services, services, and online services are used interchangeably herein. The services provided by the system of this invention, in one or more embodiments, may be provided by a service provider. A service provider is an entity that operates and maintains the computing systems and environment, such as server systems and infrastructures that enable the delivery of information. Typically, server architecture includes components (e.g., hardware, software, and communication lines) that store and offer electronic or online services.

In the following, numerous specific details are set forth to provide a thorough description of various embodiments of the invention. Certain embodiments of the invention may be practiced without these specific details or with some variations in detail. In some instances, features not pertinent to the novelty of the system are described in less detail so as not to obscure other aspects of the invention.

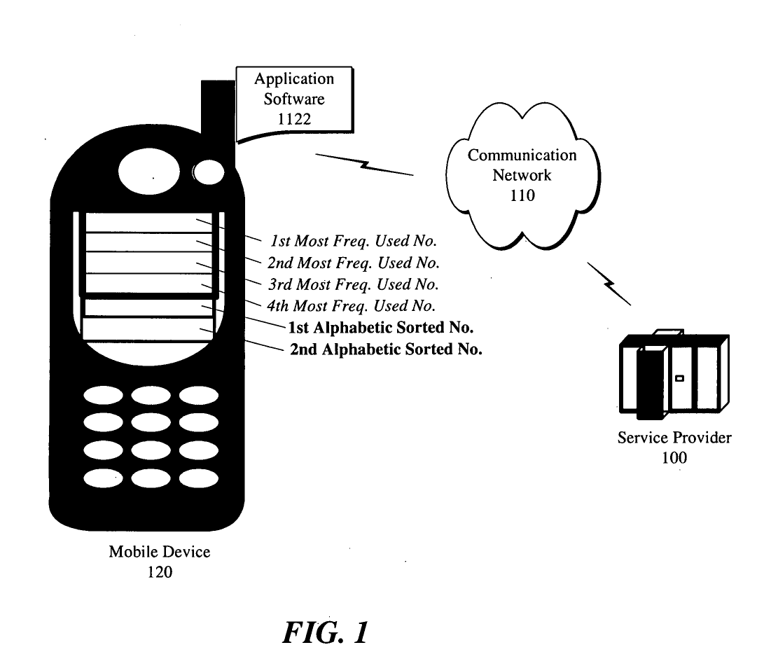

Referring to the drawings, FIG. 1 illustrates an exemplary communications environment in which the system of the present invention may operate. In accordance with one aspect of the invention, the system environment comprises a service provider 100, a communication network 110, and a mobile device 120. The service provider 100 and mobile device 120 are connected by way of the communication network 110. The terms “connected,” “coupled,” or any variant thereof, mean any connection or coupling, either direct or indirect, between two or more elements. The coupling or connection between the elements can be physical, logical, or a combination thereof.

In one embodiment, the communication network 110 provides the medium and infrastructure for transmitting digital or analog signals between service provider 100 and mobile device 120. In certain embodiments, mobile device 120 is a cellular telephone and communication network 110 is a wireless telephone network, for example. Mobile device 120, service provider 100 and communication network 110, however, may be implemented over any type of mobile, fixed, wired or wireless communication technology (e.g., landline telephony, cellular, radio, satellite, etc.).

One of ordinary skill in the art will appreciate that communication network 110 may advantageously be comprised of one or a combination of various types of networks without detracting from the scope of the invention. Such networks can, for example, comprise personal area networks (PANs), local area networks (LANs), wide area networks (WANs), public, private or secure networks, value-added networks, interactive television networks, wireless communications networks, two-way cable networks, satellite networks, interactive kiosk networks, cellular networks, personal mobile gateways (PMGs) and/or any other suitable communications network that can provide a means of communication between mobile device 120 and service provider 100.

In some embodiments, communication network 110 can be a part of the world wide web (i.e., the Internet). The Internet, in a well-known manner, connects millions of computers world wide through standard common addressing systems and communications protocols (e.g., Transmission Control Protocol/Internet Protocol (TCP/IP), HyperText Transport Protocol) creating a vast communications network.

In either context, mobile device 120 can communicate with service provider 100 to send and receive audio data or electronic packets of information, in form of electronic requests and responses. In a particular embodiment, the packets are constructed based on a messaging service, such as short messaging service (SMS), instant messenger (IM) service, or multimedia messaging service (MMS). SMS, IM and MMS enable messages comprising text or multimedia content to be communicated to mobile device 120.

In one embodiment, service provider 100 is a wireless communications service provider (e.g., Sprint, AT&T, Verizon, etc.). Depending on implementation, application software 1122 is executed on either service provider 100 or mobile device 120 (or in a distributed environment comprising service provider 100 and mobile device 120) to track the most frequently used contact information, such as telephone numbers, email addresses, internet protocol (IP) addresses, or other information associated with the process of initiating communication with a location, person, or other entity.

More particularly, in accordance with one aspect of the invention, application software 1122 is installed or executed on one of mobile device 120, service provider 100, a third party portal, or a combination of said systems to display the most frequently used contact information on a prominent position -on mobile device 120's screen.

In the following, application software 1122 is described as applicable to a speed dial feature of a mobile terminal, for tracking the most frequently dialed numbers. This particular feature is discussed for the purpose of brevity and by way of example. It should be understood that in other embodiments application software 1122 may be implemented to track the most frequently used email addresses, for example, or other contact information utilized for communicating information to another party.

As used herein, the terms mobile device, third party portal, service provider and communication network are to be viewed as designations of one or more computing environments that comprise application, client or server software for servicing requests submitted by respective software included in devices or other computing systems connected there to. These terms are not to be otherwise 1S limiting in any manner. Application software 1122, for example, may be comprised of one or more modules that execute on one or more computing systems, as described in further detail below.

In one embodiment, application software 1122 is implemented to allow a user to define a portion of mobile device 120's display for rendering a list of the most frequently dialed numbers, for example. This portion of the display may be either statically or dynamically defined. That is, application software 1122 may be used to customize the display to show N most frequently dialed numbers automatically under a first menu option, or one or more numbers that have been dialed more than X times, under a second menu option, for example.

In certain embodiments, when a user attempts to browse through a contact list stored in mobile device 120's memory, application software 1122 can be programmed to cause the N most frequently used contact information in the list to be listed on a prominent portion of the display (e.g., the top of the list). As show in FIG. 1, for example, if N is equal to four, then the most frequently dialed numbers will be displayed on the top most four entries of the contact list, and the other numbers in the list are listed below them.

The N most frequently dialed numbers may be sorted in order of the highest frequency. That is, the most frequently dialed number among the N most frequently dialed numbers (i.e., 1^{st} most frequently used number) will be listed first. And, the least frequently dialed number among the N most frequently dialed numbers (i.e., 4^{th} most frequently used number, if N=4) is listed last. The remaining numbers in the contact list are displayed in another order (e.g., alphabetic order, random order, stored order, etc.), for example, below the N most frequently dialed numbers.

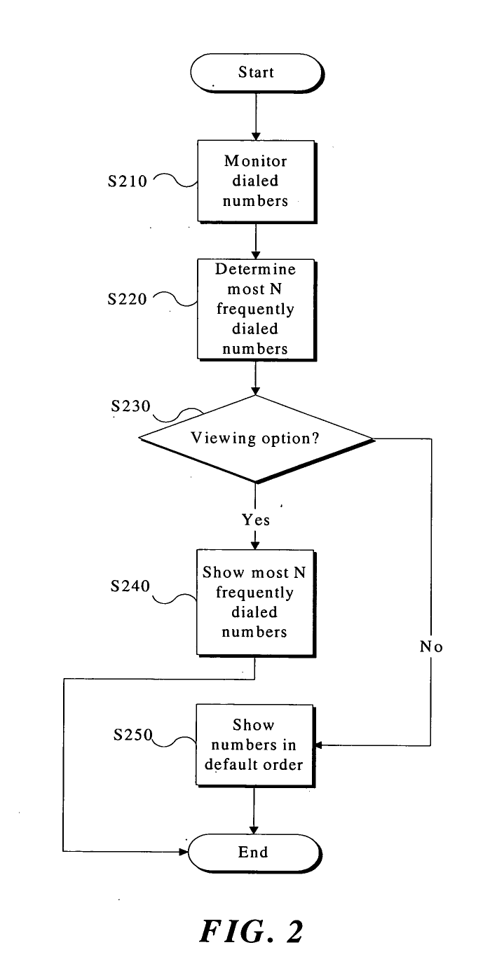

Referring to FIG. 2, in accordance with one aspect of the invention, application software 1122 or a component thereof is executed on service provider 100 or mobile device 120, or both, to monitor dialed numbers (S210). As such, each time a number is dialed—or an email, IM, or SMS message is sent—application software 1122 processes the related information to determine the most N frequently dialed numbers (S220).

In one embodiment of the invention, where mobile device 120 has limited display capabilities, for example, N is a number less than 10. It is noteworthy, that the number N may be adjusted by the user based on his or her preference. Thus, once the most N frequently dialed numbers are determined, application software 1122 determines if a viewing option has been selected by the user (S230). If so, then application software 1122 displays the most N frequently dialed numbers in accordance with the viewing option (S240).

The viewing option can be determined, in one embodiment, based on the value of N, or the location on the display the numbers are going to be displayed. As noted earlier, N may be a small number so that many of the N most frequently dialed numbers can be displayed on the screen, for example. The display location may be a prominent location (e.g., top of the contact list) or a non-prominent location (e.g., a separate menu screen).

If a custom viewing option has not been configured, then the most frequently dialed numbers are displayed in a default order (S250). The default order is selected, for example, by mobile device 120's manufacturer or service provider 100, in accordance with one embodiment. The arrangement of the numbers and the location of display may be a function of application software 1122 executed on mobile device 120, service provider 100, a PMG server,¹ or a third party portal connected to communication network 110.
¹ A more detailed description of the PMG architecture is provided in U.S. patent application Ser. No. 09/850399, filed on May 7, 2001, the entire content of which is hereby incorporated by reference here.

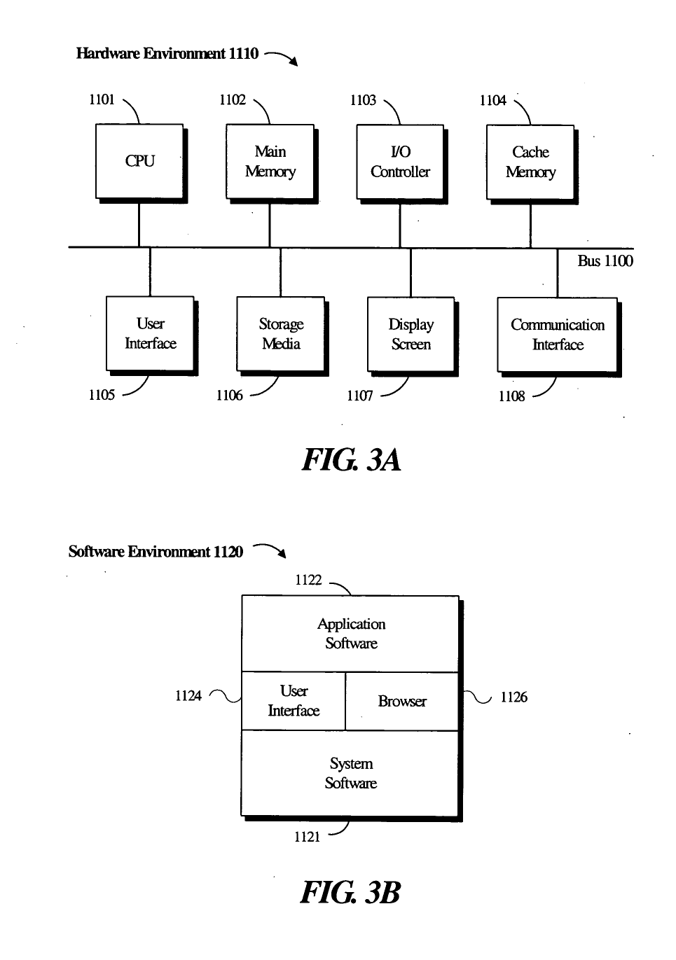

In one or more embodiments of the system, service provider 100, communication network 110, and mobile device 120 comprise a controlled computing system environment that can be presented largely in terms of hardware components and software code executed to perform processes that achieve the results contemplated by the system of the present invention. A more detailed description of such system environment is provided below with reference to FIGS. 3A and 3B.

As shown, a computing system environment is composed of two environments, a hardware environment 1110 and a software environment 1120. The hardware environment 1110 comprises the integrated or distributed circuitry, machinery and equipment that provide an execution environment for the software. The software provides the execution instructions for the hardware. It should be noted that certain hardware and software components may be interchangeably implemented in either form, in accordance with different embodiments.

Software environment 1120 is divided into two major classes comprising system software 1121 and application software 1122. System software 1121 comprises control programs, such as the operating system (OS) and information management systems that instruct the hardware how to function and process information.

Application software 1122 is a program that performs a specific task. In some embodiments of the invention, system and application software 1122 are implemented and executed on one or more hardware environments to accommodate display of most frequently used information on mobile device 120.

Referring to FIG. 3A, an embodiment of application software 1122 can be implemented as computer software in the form of computer readable code executed on a general purpose hardware environment 1110 that comprises a central processor unit (CPU) 1101, a main memory 1102, an input/output controller 1103, optional cache memory 1104, a user interface 1105 (e.g., keypad, pointing device, etc.), storage media 1106 (e.g., hard drive, memory, etc.), a display screen 1107, a communication interface 1108 (e.g., a network card, a modem, an integrated services digital network (ISDN) card, a wireless chipset, etc.), and a system synchronizer (e.g., a clock).

Processor 1101 may or may not include cache memory 1104 utilized for storing frequently accessed information. A communication mechanism, such as a bi-directional data bus 1100, can be utilized to provide for means of communication between system components. Hardware Environment 1110 is capable of communicating with local or remotes systems connected to a communications network (e.g., a PAN or a WAN) through communication interface 1108.

In one or more embodiments, hardware environment 1110 may not include all the above components, or may include additional components for additional functionality or utility. For example, hardware environment 1110 can be a laptop computer or other portable computing device that can send messages and receive data through communication interface 1108. Hardware environment 1110 may also be embodied in an embedded system such as a set-top box, a personal data assistant (PDA), a wireless communication unit (e.g., cellular phone), or other similar hardware platforms that have information processing and/or data storage and communication capabilities. For example, in embodiments of the system mobile device 120 may be a PMG phone or equivalent.

In certain embodiments, communication interface 1108 can send and receive electrical, electromagnetic, or optical signals that carry digital data streams representing various types of information including program code. If communication is established via the Internet, hardware environment 1110 may transmit program code through an Internet connection. The program code can be executed by central processor unit 1101 or stored in storage media 1106 or other non-volatile storage for later execution.

Program code may be transmitted via a carrier wave or may be embodied in any other form of computer program product. A computer program product comprises a medium configured to store or transport computer readable code or a medium in which computer readable code may be embedded. Some examples of computer program products are CD-ROM disks, ROM cards, floppy disks, magnetic tapes, computer hard drives, and network server systems.

In one or more embodiments of the invention, processor 1101 is a microprocessor manufactured by Motorola, Qualcomm, Texas Instruments, Intel, or Sun Microsystems Corporations. The named processors are for the purpose of example only. Any other suitable microprocessor, microcontroller, or microcomputer may be utilized.

Referring to FIG. 3B, software environment 1120 is stored in storage media 1106 and is loaded into memory 1102 prior to execution. Software environment 1120 comprises system software 1121 and application software 1122. Depending on system implementation, certain aspects of software environment 1120 can be loaded on one or more hardware environments 1110.

System software 1121 comprises control software such as an operating system that controls the low-level operations of hardware environment 1110. Low-level operations comprise the management of the system's resources such as memory allocation, file swapping, and other core computing tasks. In one or more embodiments of the invention, the operating system comprises at least one of Symbian, Nucleus, Microsoft Windows, Palm, or Macintosh operating systems. However, any other suitable operating system may be utilized.

Application software 1122 can comprise one or more computer programs that are executed on top of system software 1121 after being loaded from storage media 1106 into memory 1102. In a client-server architecture, application software 1122 may comprise client software and server software. Referring to FIG. 1, for example, in one embodiment of the invention, client software is executed on mobile device 120 and server software is executed on service provider 100.

Software environment 1120 may also comprise web browser software 1126 for communicating with the Internet. Further, software environment 1120 may comprise a user interface 1124 (e.g., a Graphical User Interface (GUI)) for receiving user commands and data. The commands and data received are processed by the software applications that run on the hardware environment 1110. The hardware and software architectures and environments described above are for purposes of example only. One or more embodiments of the invention may be implemented in any type of system architecture or processing environment.

The above exemplary embodiments of the invention are described as applicable to systems and corresponding methods that facilitate recognizing and displaying most frequently used information on a mobile device 120. In one exemplary embodiment, logic code for performing these methods is implemented in the form of, for example, application software 1122. The logic code, in one embodiment, may be comprised of one or more modules that execute on one or more processors in a distributed or non-distributed communication model.

It should also be understood that the programs, modules, processes, methods, and the like, described herein are but an exemplary implementation and are not related, or limited, to any particular computer, apparatus, or computer programming language. Rather, various types of general-purpose computing machines or devices may be used with logic code implemented in accordance with the teachings provided, herein. Further, the order in which the steps of the present method are performed is purely illustrative in nature. In fact, the steps can be performed in any order or in parallel, unless indicated otherwise in the present disclosure.

The method of the present invention may be performed in either hardware, software, or any combination thereof. In particular, the present method may be carried out by software, firmware, or macrocode operating on a computer or computers of any type. Additionally, software embodying the present invention may comprise computer instructions and be stored in a recording medium (e.g., memory stick, ROM, RAM, magnetic media, punched tape or card, compact disk (CD), DVD, etc.). Furthermore, such software may be transmitted in the form of a computer signal embodied in a carrier wave, and through communication networks by way of Internet portals or websites, for example. Accordingly, the present invention is not limited to any particular platform, unless specifically stated otherwise in the present disclosure.

The present invention has been described above with reference to preferred embodiments. However, those skilled in the art will recognize that changes and modifications may be made in these preferred embodiments without departing from the scope of the present invention.

The embodiments described above are to be considered in all aspects as illustrative only and not restrictive in any manner. Thus, other system architectures, platforms, and implementations that can support various aspects of the invention may be utilized without departing from the essential characteristics as described herein. These and various other adaptations and combinations of features of the embodiments disclosed are within the scope of the invention. The invention is defined by the claims and their full scope of equivalents.

1. A method of displaying most frequently used information on a mobile communication device, the method comprising:
monitoring usage of a plurality of contact information associated with a process for initiating communication with an entity, wherein said plurality of contact information is stored in a database accessible by the mobile communication device;
determining N most frequently used contact information from among said plurality of contact information stored in the database; and
displaying the N most frequently used contact information in a first portion of the mobile communication device's display, in response to a user request to view a list comprising the plurality of contact information stored in the database.

2. The method of claim 1, wherein the contact information comprises a telephone number.

3. The method of claim 1, wherein the contact information comprises a name.

4. The method of claim 1, wherein the contact information comprises an email address.

5. The method of claim 1, wherein the contact information comprises a destination identifier.

6. The method of claim 1, wherein the database is implemented in at least one of the mobile communication device and a server system connected to the mobile communication device.

7. The method of claim 1, wherein the first portion of mobile communication device's display comprises a prominent area of the display.

8. The method of claim 7, wherein the prominent area comprises a position at beginning of the list comprising the plurality of contact information stored in the database.

9. The method of claim 1, wherein the determining step comprises determining whether a first contact information is used more than X times.

10. The method of claim 1, wherein the determining step comprises including the first contact information in a list of N most frequently used contact information, when the first contact information is used more than X times.

11. A mobile communication device comprising:
circuitry for monitoring usage of contact information associated with a process for initiating communication with an entity, wherein said contact information is stored in a database accessible by the mobile communication device;
circuitry for determining N most frequently used contact information from among said contact information stored in the database; and
circuitry for displaying the N most frequently used contact information in a first portion of the mobile communication device's display, in response to a user request to view the contact information stored in the database.

12. The mobile communication device of claim 11, wherein the contact information comprises a telephone number.

13. The mobile communication device of claim 11, wherein the contact information comprises a name corresponding to a telephone number.

14. The mobile communication device of claim 11, wherein the contact information comprises an email address.

15. The mobile communication device of claim 11, wherein the contact information comprises an IP address.

16. The mobile communication device of mobile communication device 11, wherein the database comprises a contact list comprising a plurality of contact information.

17. The mobile communication device of claim 11, wherein the first portion of mobile communication device's display comprises a prominent area of the display.

18. The mobile communication device of claim 17, wherein the prominent area comprises a position at beginning of a contact list comprising said contact information stored in the database.

19. The mobile communication device of claim 11, further comprising:
circuitry for determining whether a first contact information is used more than X times; and
circuitry for including the first contact information in a first list of N most frequently used contact information, when the first contact information is used more than X times.

20. The mobile communication device of claim 19, wherein the first list is stored in a memory of at least one of the mobile communication device and a remote computer connected to the mobile communication device.
